(19) United States
(12) Patent Application Publication
(10) Pub. No.: US 2026/0371302 A1
(43) Pub. Date: Nov. 19, 2026

(54) POSITIONING SYSTEM AND POSITIONING METHOD

(71) Applicant: SHARP KABUSHIKI KAISHA, Sakai City, Osaka (JP)

(72) Inventors: TOMOKO UEKI, Sakai City, Osaka (JP); TSUYOSHI KAMADA, Sakai City, Osaka (JP); Takumi NISHINA, Sakai City, Osaka (JP); SHUN UEKI, Sakai City, Osaka (JP)

(21) Appl. No.: 19/471,003

(22) PCT Filed: Oct. 6, 2023
(86) PCT No.: PCT/JP2023/036499

§ 371 Date: Sep. 30, 2025

(30) Foreign Application Priority Data
Mar. 31, 2023 (JP) 2023-056812

(51) Int. Cl. H04W 64/00

(52) U.S. Cl. CPC H04W 64/00

(57) ABSTRACT

A positioning system includes: a plurality of transmitting terminals each of which transmits a radio wave; and a receiving terminal including a receiving unit that receives a plurality of the radio waves each transmitted from a corresponding one of the plurality of transmitting terminals; and a positioning unit that combines the plurality of radio waves to perform positioning, wherein the plurality of radio waves includes a same identifier.

### TECHNICAL FIELD

The present disclosure relates to a positioning system and a positioning method. The present application claims priority from Japanese Patent Application JP2023-56812 filed on Mar. 31, 2023, the content of which is hereby incorporated by reference into this application.

### BACKGROUND ART

Patent Document 1 discloses a technique of calculating an average value of reception strengths of signals transmitted from a plurality of radio beacons registered for a same area. Among average values of reception strengths for a plurality of areas, the technique finds areas in which average values of reception strengths exceed a set minimum value and determines that a person carrying a receiving terminal is in an area having a largest average value among the found areas.

### CITATION LIST

### Patent Literature

Patent Document 1: US Patent Application Publication No. 2021/0235229

### SUMMARY

### Technical Problems

As to the technique disclosed in Patent Document 1, a plurality of radio beacons has to be registered in advance on an application for each of the areas. Hence, the technique disclosed in Patent Document 1 requires the user to register the radio beacons himself or herself for each area. Thus, the plurality of radio beacons might not be readily placed in the area. Hence, an aspect of the present disclosure sets out to provide a positioning system and a positioning method capable of readily performing positioning using a plurality of radio waves each transmitted from a corresponding one of a plurality of transmitting terminals.

### Solution to Problems

A positioning system according to an aspect of the present disclosure includes: a plurality of transmitting terminals each of which transmits a radio wave; and a receiving terminal including: a receiving unit that receives a plurality of the radio waves each transmitted from a corresponding one of the plurality of transmitting terminals; and a positioning unit that combines the plurality of radio waves to perform positioning, wherein the plurality of radio waves includes a same identifier.

A positioning method according to an aspect of the present disclosure includes: receiving a plurality of radio waves each transmitted from a corresponding one of a plurality of transmitting terminals and including a same identifier; and combining the plurality of radio waves to perform positioning.

### BRIEF DESCRIPTION OF DRAWINGS

FIG. 1 is a block diagram illustrating an exemplary configuration of a positioning system.

FIG. 2 is a block diagram illustrating an exemplary configuration of a transmitting terminal according to a first embodiment.

FIG. 3 is a block diagram illustrating an exemplary configuration of a receiving terminal according to the first embodiment.

FIG. 4 is a table illustrating an example of a reception signal log.

FIG. 5 is a flowchart showing an exemplary operation performed on the receiving terminal according to the first embodiment.

FIG. 6 is a diagram illustrating an example of a plurality of transmitting terminals placed in each of a plurality of areas.

FIG. 7 is a diagram illustrating exemplary positions of a plurality transmitting terminals and a receiving terminal.

FIG. 8 is a block diagram illustrating an exemplary configuration of a transmitting terminal according to a fourth embodiment.

FIG. 9 is a diagram illustrating an example of a plurality of transmitting terminals placed in each of a plurality of areas.

### DESCRIPTION OF EMBODIMENTS

### First Embodiment

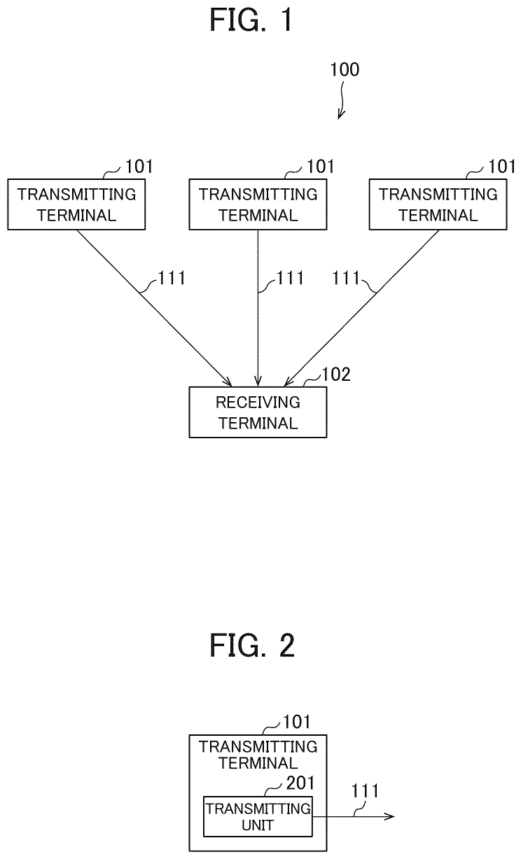

With reference to FIGS. 1 to 6, a first embodiment will be described below. Note that, throughout the drawings, like reference signs denote identical or similar constituent features. Such features will not be repeatedly elaborated upon.

FIG. 1 is a block diagram illustrating an exemplary configuration of a positioning system 100. The positioning system 100 includes: a plurality of transmitting terminals 101; and a receiving terminal 102.

Each of the plurality of transmitting terminals 101 transmits a radio wave 111 including a same identifier. Specifically, the plurality of transmitting terminals 101 is placed in each of areas and transmits radio, and each of the transmitting terminals 101 transmits the radio wave 111 by the Near-Field Communication. For example, the identifier is a Bluetooth® Device Address. That is, the plurality of transmitting terminals 101 placed in each of the areas transmits the radio waves 111 including an identifier different in each of the areas.

The receiving terminal 102 receives a plurality of the radio waves 111 transmitted from the plurality of transmitting terminals 101 and combines the plurality of radio waves 111 to perform positioning. Examples of the receiving terminal 102 include a smart watch, a card-type device, a ring-type device, an eye-glass-type device, and a garment-type device.

Note that the positioning system 100 has an area for identifying a position of the receiving terminal 102. At least one or more transmitting terminals 101 are placed in the area, and the transmitting terminals 101 transmit the radio waves 111 each including a uniquely determined identifier.

If the plurality of transmitting terminals 101 is placed in one area, the transmitting terminals 101 placed in the area transmit the radio waves 111 each including an identifier uniquely determined in common with all the transmitting terminals 101 placed in the area.

A range of the area may be determined in accordance with all the transmitting terminals 101 that are the sources of the radio waves 111 including the same identifier. The range of the area may be a range within a reach of the radio wave 111 transmitted from at least one transmitting terminal 101 among all the transmitting terminals 101. Note that the plurality of transmitting terminals 101 disposed in the range of the area does not have to be placed at constant intervals.

Note that the positioning system 100 may have a plurality of areas for identifying the positions of the receiving terminal 102. Each of the plurality of areas has a transmitting terminal 101. However, the transmitting terminal 101 is not placed across the plurality of areas. The transmitting terminal 101 is placed in one area. Hence, an identifier associated with the area can be estimated from the identifier included in the radio wave 111 to be transmitted from the transmitting terminal 101. Note that if the receiving terminal 102 is positioned in a region in which the plurality of areas overlaps, an area to be identified is determined in accordance with the reception strengths of the radio waves 111 received by the receiving terminal 102. For example, the reception strengths of the received radio waves 111 are compared, and the area is determined in accordance with an identifier of a radio wave 111 having a highest reception strength. Hence, the positioning system 100 having a plurality of areas can perform positioning of the receiving terminal 102.

FIG. 2 is a block diagram illustrating an exemplary configuration of a transmitting terminal 101. The transmitting terminal 101 includes a transmitting unit 201. The transmitting unit 201 transmits the radio wave 111 at predetermined intervals.

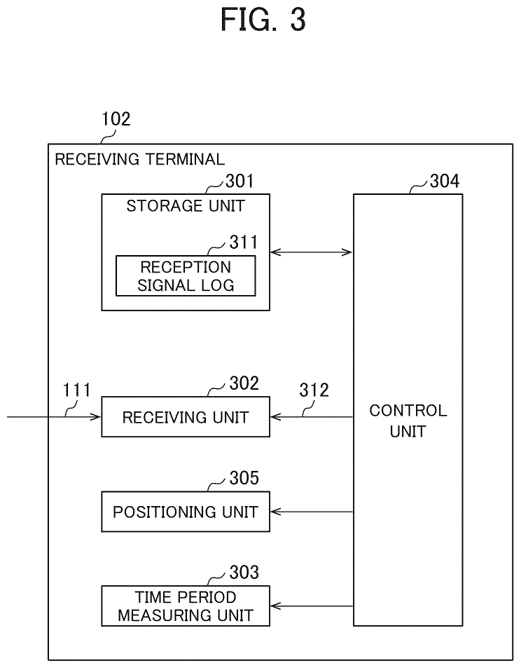

FIG. 3 is a block diagram illustrating an exemplary configuration of the receiving terminal 102. The receiving terminal 102 includes: a storage unit 301; a receiving unit 302; a time period measuring unit 303; a control unit 304; and a positioning unit 305.

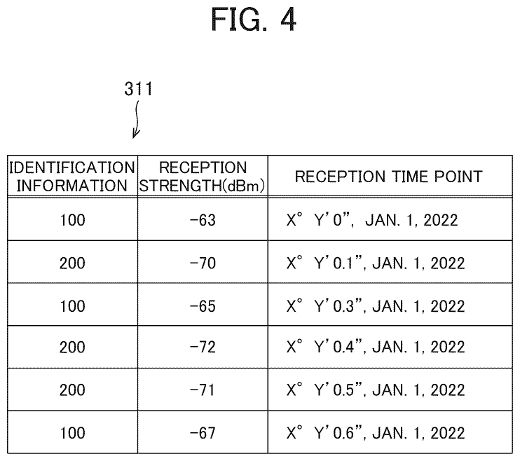

The storage unit 301 is a recording medium capable of recording, for example, various data and programs. The storage unit 301 is, for example, a hard disk, a solid-state drive (SSD), and a semiconductor memory. The storage unit 301 stores such data as a reception signal log 311 (see FIG. 4).

The receiving unit 302 receives the plurality of radio waves 111 each transmitted from a corresponding one of the plurality of transmitting terminals 101. Each of the plurality of radio waves 111 includes a same identifier.

The control unit 304 and the positioning unit 305 execute various kinds of processing in accordance with a program and data stored in the storage unit 301. For example, the control unit 304 and the positioning unit 305 are implemented in the form of, for example, a processor such as a central processing unit (CPU).

The time period measuring unit 303 measures an elapsed time period from a start of a reception period 312.

The control unit 304 causes the receiving unit 302 to receive the plurality of radio waves 111. Specifically, the control unit 304 causes the receiving unit 302 to receive the plurality of radio waves 111 from the start of the reception period 312 to an end of the reception period 312. Then, the control unit 304 registers in the reception signal log 311 the identifiers included in the radio waves 111, the reception strengths of the radio waves 111, and reception time points of the radio waves 111 in association with one another.

The positioning unit 305 combines the plurality of radio waves 111 to perform positioning. That is, the positioning unit 305 combines the plurality of radio waves 111 transmitted from the transmitting terminals 101 placed in the same area and received within the reception period 312 to perform positioning. For example, the combining the plurality of radio waves 111 is calculating an average reception strength of the plurality of radio waves 111 received during the reception period 312.

FIG. 4 is a table illustrating an example of the reception signal log 311. The reception signal log 311 associates with one another the identifiers, the reception strengths, and the reception time points of the radio waves 111 received from the start of the reception period 312 to the end of reception period 312.

For example, the reception signal log 311 shown in FIG. 4 as an example indicates that the receiving unit 302 received a pulse, which is included in a radio wave 111 including an identifier indicating 100, with reception strengths of −63 dBm, −65 dBm, and −67 dBm from the start of the reception period 312 to the end of the reception period 312. Furthermore, the reception signal log 311 shown in FIG. 4 as an example indicates that the receiving unit 302 received a pulse, which is included in a radio wave 111 including an identifier indicating 200, with reception strengths of −70 dBm, −72 dBm, and −71 dBm from the start of the reception period 312 to the end of the reception period 312. Here, the receiving unit 302 does not identify the sources of the radio waves 111. Hence, the sources of the plurality of radio waves 111 including the same identifier may be the same or different from each other.

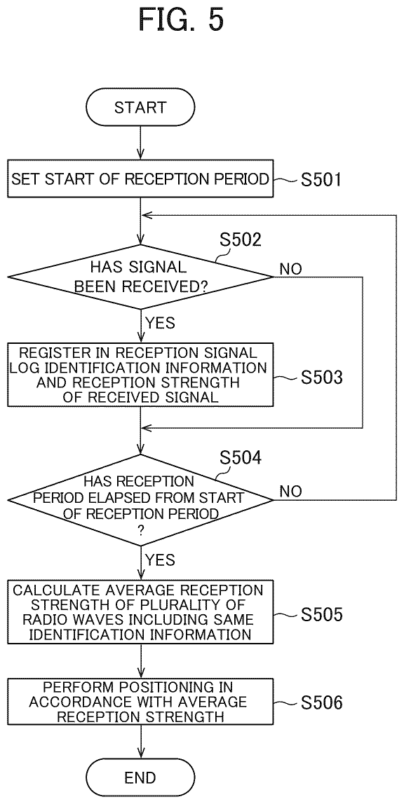

FIG. 5 is a flowchart showing an exemplary operation performed on the receiving terminal 102 according to this embodiment.

At Step S501, the time period measuring unit 303 sets the start of the reception period 312. During the reception period, the receiving unit 302 is on standby until receiving a radio wave 111

At Step S502, the control unit 304 determines whether the receiving unit 302 has received the radio wave 111. At Step S502, if the receiving unit 302 has not received the radio wave 111, the control unit 304 proceeds with the processing to Step S504. Whereas, at Step S502, if the receiving unit 302 has received the radio wave 111, then, at Step S503, the control unit 304 registers in the reception signal log 311 an identifier included in the received radio wave 111 and a reception strength of the received radio wave 111 in association with each other. Then, the control unit 304 proceeds with the processing to Step S504.

At Step S504, the receiving unit 302 determines whether the reception period 312 has elapsed from the start set at Step S501 for the reception period 312. At Step S504, if the reception period 312 has not elapsed from the start of the reception period 312, the control unit 304 returns the processing back to Step S502. Whereas, at Step S504, if the reception period 312 has elapsed from the start of the reception period 312, the control unit 304 proceeds with the processing to Step S505.

At Step S505, the positioning unit 305 calculates an average reception strength of a plurality of the radio waves 111 each transmitted from a corresponding one of the plurality of transmitting terminals 101 and including a same identifier. That is, the positioning unit 305 calculates the average reception strength for the radio waves 111 including the same identifier. Specifically, the positioning unit 305 calculates an average value of the reception strengths associated in the reception signal log 311 with the reception time points within the reception period and with the same identifier. Here, the average value serves as an average reception strength of the plurality of radio waves 111 including the same identifier. Thaks to such a feature, the positioning unit 305 can calculate the average reception strength of the plurality of radio waves 111 for each of the areas.

For example, suppose a case where the storage unit 301 stores the reception signal log 311 illustrated in FIG. 4 as an example. Here, for the radio waves 111 including the identifier indicating 100, the positioning unit 305 calculates an average reception strength of −65 dBm. Furthermore, for the radio waves 111 including the identifier indicating 200, the positioning unit 305 calculates an average reception strength of −71 dBm.

At Step S506, the positioning unit 305 performs positioning in accordance with the average reception strength calculated at Step S505. Specifically, when the receiving terminal 102 receives a plurality of radio waves 111 including identifiers different from one another, the positioning unit 305 calculates an average reception strength for each of the identifiers. Then, using an identifier representing a highest average reception strength among the identifiers included in the plurality of radio waves 111 and different from one another, the positioning unit 305 identifies an area in which the receiving terminal 102 is present. For example, when the storage unit 301 stores the reception signal log 311 illustrated in FIG. 4 as an example, the positioning unit 305 determines that the receiving terminal 102 is present in an area having a transmitting terminal 101 transmitting the radio wave including the identifier indicating 200.

When the positioning unit 305 performs positioning by calculating an average reception strength from the reception strengths of the pulses included in the received radio waves 111, the positioning can be performed with higher accuracy as the receiving unit 302 receives a larger number of pulses. Hence, in the positioning system 100, each of the transmitting terminals 101 transmits a radio wave 111 including a different identifier for each of the areas. Hence, in the positioning system 100, without distinction between the sources of the radio waves 111, the receiving terminal 102 can calculate an average reception strength of the radio waves 111 transmitted from the plurality of transmitting terminals 101 placed in the same area. In accordance with the calculated average reception strength, the receiving terminal 102 can perform positioning. Thus, in the positioning system 100, the receiving terminal 102 can readily perform positioning using the plurality of radio waves 111 each transmitted from a corresponding one of the plurality of transmitting terminals 101.

Furthermore, in the positioning system 100 according to this embodiment, the transmitting terminals 101 to be placed in the area may transmit the radio waves 111 including the same identifier. Such a feature eliminates the need for registering, in the receiving terminal 102 in advance, the plurality of transmitting terminals 101 placed in the area. Hence, the positioning system 100 according to this embodiment can have the plurality of transmitting terminals 101 readily placed in the area and perform positioning in accordance with the reception strengths of the radio waves 111 transmitted from the plurality of transmitting terminals 101.

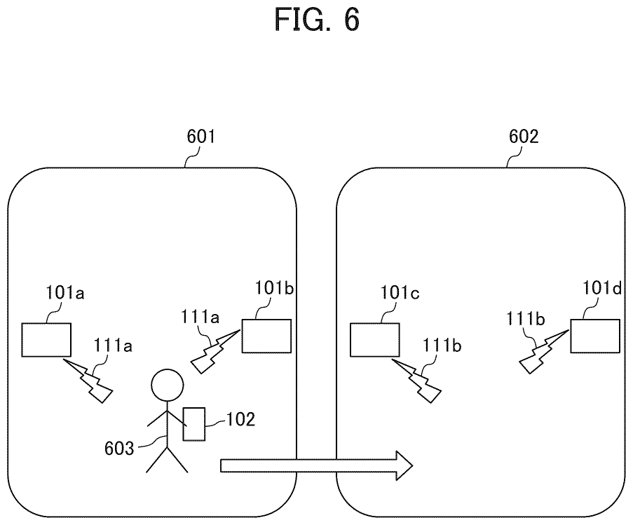

FIG. 6 is a diagram showing an example of transmitting terminals 101a to 101d placed in areas 601 and 602. In the area 601, the transmitting terminal 101a and the transmitting terminal 101b are placed. Each of the transmitting terminals 101a and 101b transmits a radio wave 111a. A plurality of the radio waves 111a transmitted from the transmitting terminals 101a and 101b includes a same identifier. In the area 602, the transmitting terminal 101c and the transmitting terminal 101d are placed. Each of the transmitting terminals 101c and 101d transmits a radio wave 111b. A plurality of the radio waves 111b transmitted from the transmitting terminals 101c and 101d includes a same identifier.

For example, if a user 603 carrying a receiving terminal 102a is present in the area 601, an average reception strength of the plurality of radio waves 111a is higher than an average reception strength of the plurality of radio waves 111b. However, if the user 603 moves from the area 601 to the area 602, the average reception strength of the plurality of radio waves 111b becomes greater than the average reception strength of the plurality of radio waves 111a. Hence, the positioning unit 305 calculates the average reception strength for each of the identifiers, thereby successfully identifying an area in which the receiving terminal 102 is present.

### Second Embodiment

Next, a second embodiment will be described below. Note that, throughout the drawings, like reference signs denote identical or similar constituent features. Such features will not be repeatedly elaborated upon. Configurations and processes having substantially the same functions as those of the first embodiment are denoted by the same reference numerals, and the description thereof will be omitted. Described will be a difference between this embodiment and the first embodiment.

In the positioning system 100 according to this embodiment, each of the radio waves 111 includes a plurality of pulses. Furthermore, during the reception period 312, the pulses to be transmitted from each of the transmitting terminals 101 among the plurality of transmitting terminals 101 are equal in number to, or smaller or equal in predetermined number than or to, the pulses to be transmitted from another transmitting terminal 101 among the plurality of transmitting terminals 101.

Hence, without disproportion in the sources of the plurality of radio waves 111, the receiving unit 302 according to this embodiment can receive the plurality of radio waves 111 transmitted from the plurality of transmitting terminals 101. As a result, without disproportion in the sources, the positioning unit 305 according to this embodiment can calculate an average reception radio wave strength from the reception strengths of the pulses included in the received radio waves 111. In accordance with the calculated average reception radio wave strength, the positioning unit 305 can perform positioning.

### Third Embodiment

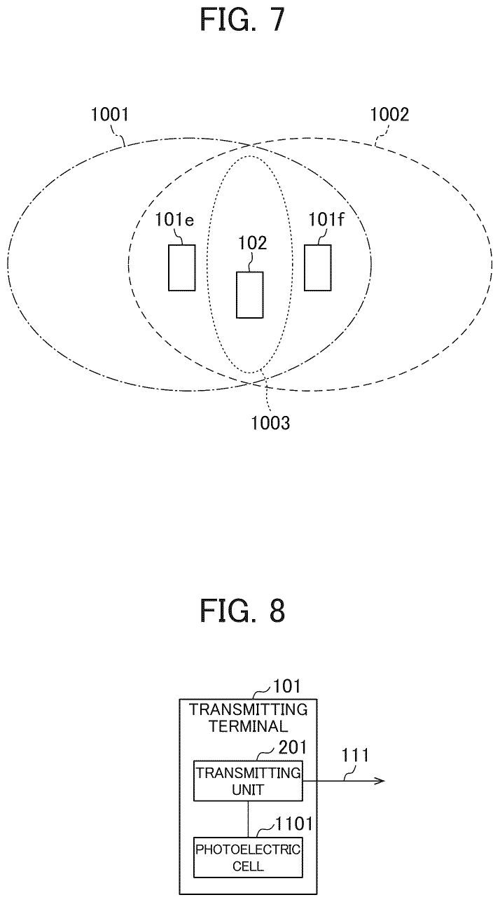

With reference to FIG. 7, a third embodiment will be described below. Configurations and processes having substantially the same functions as those of the other embodiments are denoted by the same reference numerals, and the description thereof will be omitted. Described will be a difference between this embodiment and the other embodiments.

In the positioning system 100 according to this embodiment, each of the transmitting terminals 101 among the plurality of transmitting terminals 101 is placed in a range within a reach of the radio wave 111 to be transmitted from another transmitting terminal 101 among the plurality of transmitting terminals 101. The range within a reach of the radio wave 111 is a range in which the radio wave 111 can be received at a reception strength exceeding a predetermined threshold value. In measuring the range within a reach of the radio wave 111, such extraneous disturbance factors as a shield are preferably removed because the extraneous disturbance factors can be an obstacle of communications. In addition, when one transmitting terminal 101 is transmitting the radio wave 111 and the receiving terminal 102 is placed at another transmitting terminal 101, the area within a reach of the radio wave 111 may be determined whether the receiving terminal 102 can receive the radio wave 111 to be transmitted from the one transmitting terminal 101. Furthermore, the receiving unit 302 according to this embodiment receives the plurality of radio waves 111, including the same identifier, at a position at which the receiving unit 302 is operable to receive the radio wave 111 to be transmitted from each of the transmitting terminals 101.

FIG. 7 is a diagram illustrating exemplary positions of a transmitting terminal 101e, a transmitting terminal 101f and the receiving terminal 102. Each of the transmitting terminal 101e and the transmitting terminal 101f transmits a radio wave 111. The radio waves 111 transmitted from the respective transmitting terminals 101e and 101f include a same identifier.

For example, the radio wave 111 to be transmitted from the transmitting terminal 101e is to be received at a position within a range 1001 at a reception strength exceeding a predetermined threshold value. Furthermore, the radio wave 111 to be transmitted from the transmitting terminal 101f is to be received at a position within a range 1002 at a reception strength exceeding the predetermined threshold value.

Here, for example, the receiving terminal 102 is assumed to be present at a position within a range 1003 included in the range 1001 and the range 1002. In this case, the receiving unit 302 of the receiving terminal 102 can receive the radio wave 111 to be transmitted from the transmitting terminal 101e and the radio wave 111 to be transmitted from the transmitting terminal 101f at a reception strength exceeding the predetermined threshold value. Thanks to such a feature, the positioning unit 305 of the receiving terminal 102 can calculate an average reception strength of the radio wave 111 transmitted from the transmitting terminal 101e and the radio wave 111 transmitted from the transmitting terminal 101f, and perform positioning in accordance with the calculated average reception radio wave strength.

### Fourth Embodiment

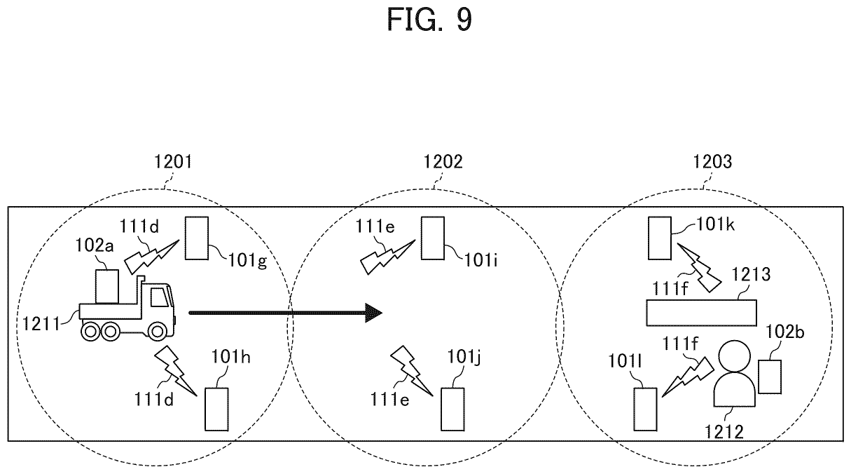

With reference to FIGS. 8 and 9, a fourth embodiment will be described. Configurations and processes having substantially the same functions as those of the other embodiments are denoted by the same reference numerals, and the description thereof will be omitted. Described will be a difference between this embodiment and the other embodiments.

In the positioning system 100 according to this embodiment, at least one or more of the plurality of transmitting terminals 101 transmits the radio waves 111 by power supplied over light. That is, at least one or more of the plurality of transmitting terminals 101 transmits the radio waves 111 by power generated with a photoelectric cell 1101 (see FIG. 8). Hence, at least one or more of the plurality of transmitting terminals 101 intermittently transmits the radio waves 111 when the ambient illumination is insufficient. The intermittent transmission means that transmission intervals of a radio wave 111 transmitted from a transmitting terminal 101 are longer with respect to a setting of the transmitting terminal 101. For example, when the transmitting terminal 101 is set to transmit the radio wave 111 at 100 ms intervals, the intermittent transmission involves transmitting the radio wave 111 at intervals longer than those of the setting, such as transmitting the radio wave 111 at 200 ms intervals. Note that, other than the transmitting terminals 101 that transmit the radio waves 111 by the power supplied over light, a transmitting terminal 101 powered by another power supply could perform the intermittent transmission. Among the plurality of transmitting terminals 101, if intervals for transmitting a radio wave 111 of one transmitting terminal 101 are longer than oscillation intervals of a radio wave 111 of another transmitting terminal 101, (e.g., if intervals of a radio wave 111 transmitted from one transmitting terminal 101 are longer than oscillation intervals of a radio wave 111 of another transmitting terminal 101 over, for example, 1000 ms), the one transmitting terminal 101 may be interpreted as performing the intermittent transmission.

Furthermore, the radio wave 111 to be transmitted from each of the transmitting terminals 101 includes a plurality of pulses. Moreover, when each of the transmitting terminals 101 transmits the plurality of radio waves 111 by power supplied over light, variations are observed of the intervals at which the pulses are transmitted from each of the transmitting terminals 101. In addition, when the transmitting terminal 101 transmits the radio wave 111 by power supplied over light, a reception strength of the radio wave 111 might fluctuate with time even if the transmitting terminal 101 and the receiving terminal 102 are suspended.

Furthermore, if each of the transmitting terminals 101 among the plurality of transmitting terminals 101 is in an environment in which the ambient illumination is insufficient, the intervals at which the pulses are transmitted might be longer in the environment than in an environment in which the ambient illumination is sufficient. Specifically, if the transmitting terminal 101 transmits the radio wave 111 by power supplied over light, the intervals at which the pulses are transmitted might be longer as the ambient illumination is weaker. As a result, the number of pulses received by the receiving terminal 102 may be smaller when the ambient illumination is insufficient than when the ambient illumination is sufficient.

Moreover, when the transmitting terminal 101 transmits the radio wave 111 by power supplied over light, it is difficult to shorten the transmission intervals in an environment in which the ambient illumination is sufficient. Hence, in order to improve accuracy of a result of the positioning performed by the positioning unit 305, a plurality of transmitting terminals 101 that transmits radio waves 111 including the same identifier is placed in an area. Such a feature makes it possible to transmit a sufficient number of radio waves 111.

FIG. 8 is a block diagram illustrating an exemplary configuration of a transmitting terminal 101 including the photoelectric cell 1101.

The photoelectric cell 1101 photoelectrically generates power and supplies the generated power to the transmitting unit 201.

If the ambient illumination of a transmitting terminal 101 is sufficient such that the photoelectric cell 1101 supplies the transmitting unit 201 with sufficient power, the transmitting unit 201 according to this embodiment transmits the radio wave 111 at previously set transmission intervals. Whereas, if the ambient illumination of the transmitting terminal 101 is insufficient such that the photoelectric cell 1101 does not supply the transmitting unit 201 with sufficient power, the transmitting unit 201 intermittently transmits the radio wave 111.

FIG. 9 is a diagram showing an example of a transmitting terminal 101g to a transmitting terminal 1011 placed in areas 1201 to 1203. The transmitting terminals 101g to 1011 transmit the radio waves 111 by power supplied over light.

Specifically, in the area 1201, the transmitting terminals 101g and 101h are placed. Each of the transmitting terminals 101g and 101h transmits a radio wave 111d including a same identifier. In the area 1202, the transmitting terminals 101i and 101j are placed. Each of the transmitting terminals 101i and 101j transmits a radio wave 111e including a same identifier. In the area 1203, the transmitting terminals 101k and 1011 are placed. Each of the transmitting terminals 101k and 1011 transmits a radio wave 111f including a same identifier.

Here, the areas 1201 to 1203 are in a tunnel, which is an environment with insufficient illumination. Furthermore, the transmitting terminals 101g to 1011 are placed on opposing walls of the tunnel. In this case, in the areas 1201 to 1203, the transmitting unit 201 of each of the transmitting terminals 101g to 1011 is not supplied with sufficient power. As a result, the transmitting unit 201 of each of the transmitting terminals 101g to 1011 might perform the intermittent transmission.

For example, suppose a case where a vehicle 1211 carrying the receiving terminal 102a moves from the area 1201 to the area 1202. If only one transmitting terminal 101 is placed in each of the areas 1201 and 1202, and each of the areas 1201 and 1202 is in an environment in which the ambient illumination of the one transmitting terminal 101 is insufficient, the receiving unit 302 of the receiving terminal 102a might not be able to sufficiently receive, during the reception period 312, the radio wave 111 transmitted from the one transmitting terminal 101. In this case, the positioning unit 305 of the receiving terminal 102a can neither perform positioning appropriately nor determine the area to which the receiving terminal 102a belongs.

However, if the transmitting terminals 101g to 101j are placed in the areas 1201 and 1202, the receiving unit 302 of the receiving terminal 102a might be able to receive, during the reception period 312, the radio wave 111 transmitted from at least one transmitting terminal 101 among the transmitting terminals 101g to 101j. Thanks to such a feature, the positioning unit 305 of the receiving terminal 102b can perform positioning even in an environment in which the ambient illumination of the transmitting terminals 101g to 101j is insufficient, and determine the area to which the receiving terminal 102a belongs.

Hence, even in an environment in which the ambient illumination of a transmitting terminal 101 is insufficient or in a case where a transmitting terminal 101 performs intermittent transmission, the positioning system 100 according to this embodiment has a plurality of transmitting terminals 101 placed in an area so that the plurality of transmitting terminals 101 transmits radio waves 111 including a same identifier. Thanks to such a feature, the receiving terminal 102 can perform positioning and determine the area to which the receiving terminal 102 belongs.

Furthermore, for example, suppose a case where a person 1212 carrying the receiving terminal 102b is present in the area 1203. Furthermore, suppose a case where a shield 1213 formed of metal is placed between the transmitting terminal 101k and the person 1012. In this case, the receiving terminal 102b is shielded from a radio wave from the transmitting terminal 101k. As a result, the receiving unit 302 of the receiving terminal 102b might not be able to receive the radio wave 111f transmitted from the transmitting terminal 101k.

However, if the transmitting terminal 1011 is placed in the area 1203 and the receiving terminal 102b is not shielded from a radio wave from the transmitting terminal 1011, the receiving unit 302 of the receiving terminal 102b can receive the radio wave 111f transmitted from the transmitting terminal 1011. As a result, the positioning unit 305 of the receiving terminal 102b can perform positioning in accordance with an average reception strength of the radio wave 111f transmitted from the transmitting terminal 1011, and determine the area to which the receiving terminal 102b belongs. Hence, in the positioning system 100 according to this embodiment, even in a case where the receiving terminal 102 is shielded from a radio wave from at least one transmitting terminal 101 among the plurality of transmitting terminals 101, the receiving terminal 102 can perform positioning in accordance with a reception strength of a radio wave 111 transmitted from another transmitting terminal 101 among the plurality of transmitting terminals 101.

Each of the processes executed in the above embodiments shall not be limited to the aspects of the processes exemplified in the embodiments. The functional blocks described above may be implemented as logic circuits (hardware) formed into, for example, integrated circuits, or as software using a CPU. The above embodiments may be executed on a plurality of computers. For example, the processes executed on each of the functional blocks of the receiving terminal 102 may be partially executed on another computer. Alternatively, all the processes may be shared among, and executed on, a plurality of computers.

The present disclosure shall not be limited to the above-described embodiments, and may be replaced with a configuration substantially the same as a configuration having the same advantageous effects as, or a configuration capable of achieving the same object as, the configurations described in the above embodiments. In the present disclosure, the technical aspects disclosed in different embodiments are to be appropriately combined together to implement another embodiment. Such an embodiment shall be included within the technical scope of the present disclosure. Furthermore, the technical aspects disclosed in each embodiment may be combined to achieve a new technical feature.

What is claimed is:

1. A positioning system, comprising:
a plurality of transmitting terminals each configured to transmit a radio wave; and
a receiving terminal including: a receiving unit configured to receive a plurality of the radio waves each transmitted from a corresponding one of the plurality of transmitting terminals; and a positioning unit configured to combine the plurality of radio waves to perform positioning, wherein the plurality of radio waves includes a same identifier,
wherein the plurality of transmitting terminals is placed in each of areas,
the identifier is different in each of the areas,
each of the radio waves includes a plurality of pulses, and
variations are observed of intervals at which the pulses are transmitted from each of the transmitting terminals.

2. The positioning system according to claim 1,
wherein the combining the plurality of radio waves is calculating an average reception strength of the plurality of radio waves received during a reception period.

3. The positioning system according to claim 2,
wherein each of the plurality of radio waves includes a plurality of pulses, and
during the reception period, the pulses to be transmitted from each of the plurality of transmitting terminals are equal in number to, or smaller or equal in predetermined number than or to, the pulses to be transmitted from another transmitting terminal among the plurality of transmitting terminals.

4. The positioning system according to claim 1,
wherein each of the plurality of transmitting terminals is placed in a range within a reach of the radio wave to be transmitted from another transmitting terminal among the plurality of transmitting terminals.

5. The positioning system according to claim 4,
wherein the receiving unit receives the plurality of radio waves at a position at which the receiving unit is operable to receive the radio wave.

6. (Canceled)

7. The positioning system according to claim 1,
wherein at least one or more of the plurality of transmitting terminals transmits the radio waves by power supplied over light.

8. The positioning system according to claim 1,
wherein at least one or more of the plurality of transmitting terminals intermittently transmits the radio waves.

9. (canceled)

10. A positioning method, comprising:
receiving a plurality of radio waves each transmitted from a corresponding one of a plurality of transmitting terminals and including a same identifier; and
combining the plurality of radio waves to perform positioning.
wherein the plurality of transmitting terminals is placed in each of areas,
the identifier is different in each of the areas,
each of the radio waves includes a plurality of pulses, and
variations are observed of intervals at which the pulses are transmitted from each of the transmitting terminals.
